(19) United States
(12) Patent Application Publication
(10) Pub. No.: US 2013/0199458 A1
(43) Pub. Date: Aug. 8, 2013

(54) CANINE EXERCISE AND EXERCISE TRAINING DEVICE AND METHOD

(71) Applicants: James LAPLACA, JR., Garfield, NJ (US); Anthony ACCOLA, JR., Warwick, NY (US)

(72) Inventors: James LAPLACA, JR., Garfield, NJ (US); Anthony ACCOLA, JR., Warwick, NY (US)

(21) Appl. No.: 13/566,262

(22) Filed: Aug. 3, 2012

Related U.S. Application Data
(60) Provisional application No. 61/514,628, filed on Aug. 3, 2011.

(51) Int. Cl. A01K 15/02

(52) U.S. Cl. CPC A01K 15/027
USPC 119/702; 119/712

(57) ABSTRACT

A canine exercise and training device has elastic bands which extend from the central web to each of the four limbs to provide resistance training in the course of ordinary canine gaits.

### BACKGROUND OF THE INVENTION

The present disclosure and related inventions pertain to devices and methods for canine exercise. It is well known that dogs thrive with exercise, from their evolution as roving scavengers. Most breeds are capable of many hours of activity per day at work or play. Unfortunately many domesticated dogs are forced to be sedentary by confinement for long hours, and in many cases do not have daily opportunities for even minimal exercise. This leads to boredom, chronic lethargy and weight gain. For dogs which do get some exercise during the day, it is frequently too little. Even if a dog seems content, it would in most cases be in better physical condition with a greater amount of exercise. Also, although there are many different types of toys and devices for dog play, there is a lack of devices which purposefully increase the exercise effort, efficiency and physical benefit of a dog's play time.

### SUMMARY OF THE INVENTION

The present disclosure and related inventions provide a canine exercise and exercise training device and method which offers resistance to the natural motions of a dog in various gaits of walking, trotting and running at different speeds. By elastically interconnecting the cadenced motion of the four legs, resistance is introduced to all motions of the dog without restricting the dog's movement and without otherwise interfering with the natural range of motions. By creating resistance to the motion of each leg, the motion of each leg with respect to the combined motions of all the legs, and without interfering with the natural path of motion or range of motion of the joints, increased resistance is offered to all of the muscle groups associated with the dog's movement, thus working the muscles harder than without such resistance. As in all physiological training, increased resistance to muscles requires increased cardiovascular effort and greater calorie burn, and ultimately results in an increase in muscle mass and strength and increased cardiovascular efficiency.

### DESCRIPTION OF THE DRAWINGS

FIG. 1 is a perspective view of a representative embodiment of the canine exercise and training device of the invention;

FIG. 2 is a perspective view of a distal attachment end of the canine exercise and training device of FIG. 1;

FIG. 3 is a plan view of the canine exercise and training device of FIG. 1;

FIG. 4 is a side view of the canine exercise and training device of FIG. 1;

FIG. 5 is a perspective view of an alternate embodiment of a canine exercise and training device of the invention;

FIG. 6 is a plan and partially enlarged view of the canine exercise and training device of FIG. 5;

FIG. 7 is a perspective view of an alternate distal attachment end of a canine exercise and training device of the invention;

FIG. 8 is a perspective view of an alternate distal attachment end of a canine exercise and training device of the invention;

FIG. 9 is a perspective view of an alternate distal attachment end of a canine exercise and training device of the invention.

### DESCRIPTION OF THE REPRESENTATIVE EMBODIMENTS

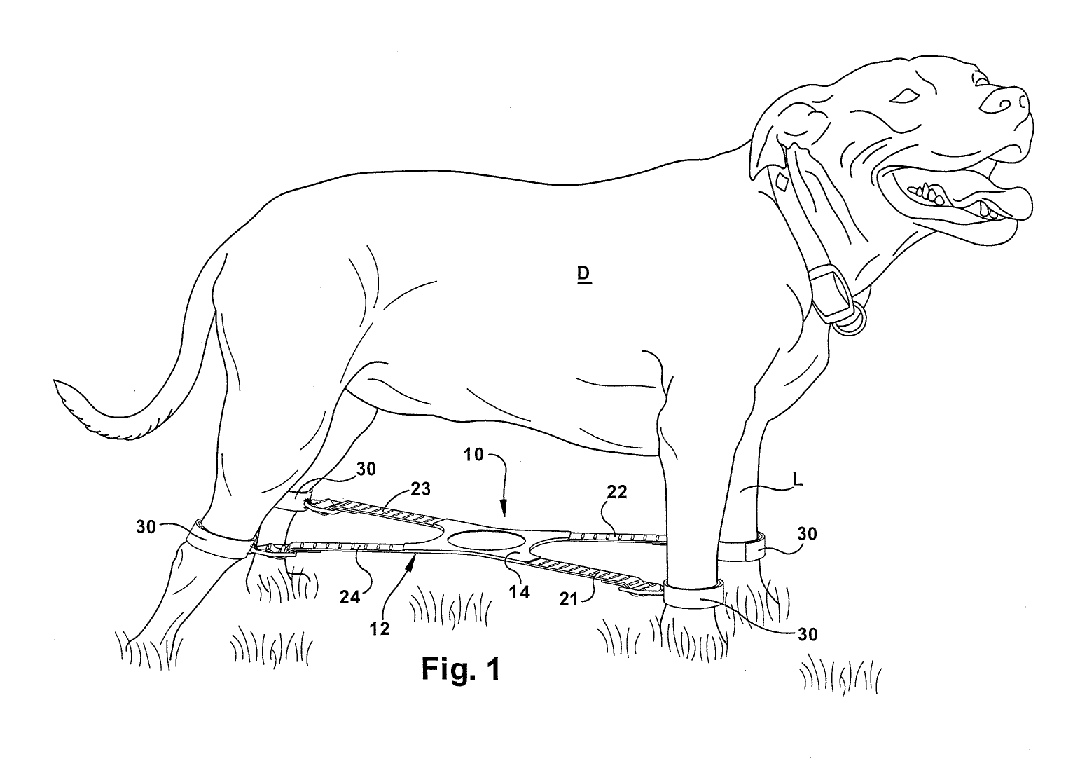

In accordance with the principles and concepts of the invention, as illustrated in the accompanying drawings, FIGS. 1-7, controlled resistance to the motion of a dog's legs in all forms of motion, gaits and at all speeds is introduced by the dog training device 10 of an elastic member, such as shown in one embodiment in FIGS. 1, 3, 5 and 6, indicated generally at 10 as properly worn by a dog D about limbs L. The device 10 has a generally X-shaped elastic member which may be formed as a single contiguous member 12 as shown, or as separate elastic members which extend from each dog leg L and which are also interconnected, for example centrally between the four dog legs. When formed as a single member 12, four elastic limb bands 21, 22, 23 and 24 extend outward from a central connecting web 14, all formed contiguously of the same elastic material, so that the connecting web 14 has the same elastic properties as each of the elastic limb bands 21-24. Alternatively, the connecting web 14 can be made of non-elastic material, or of material that has less elasticity than the elastic limb bands 21-24, and the elastic limb bands 21-24 can be mechanically attached to the connecting web 14. The amount of elasticity for the member 12 as a whole, the connecting web 14 or any of the limb bands 21-24 can be selected according to the degree of resistance desired and designed into the elastomeric material from which the components are manufactured. For example, dog trainings devices 10 of dimensions for large size dogs such as the working breeds may be made of material which provides greater resistance to stretching, i.e. more resistive force against the motion of the dog legs, and vice versa for smaller breeds. Also, the dimensions of the limb bands 21-24 can be designed along with the material properties to tailor the elastic force for any size or application.

As shown in FIG. 3, the device 10 may have a generally X-shaped configuration, with the limb bands 21, 22, 23, 24 extending from the connecting web 14 to four outward distal ends 211, 221, 231, 241. As mentioned, the proximal ends of bands 21-24 may alternatively be mechanically attached to the connecting web 14, and the connection may be flexible so that the bands are free to extend at varying angles relative to the connecting web 14. However when the connected web 14 and limb bands 21-24 are formed as a single flexible elastic structure, the limb bands 21-24 are flexible enough to move through a range of angles and positions relative to the web 14. Likewise the flexible and elastic properties of the connecting web 14 allow it to accommodate the motion of the limb bands 21-24.

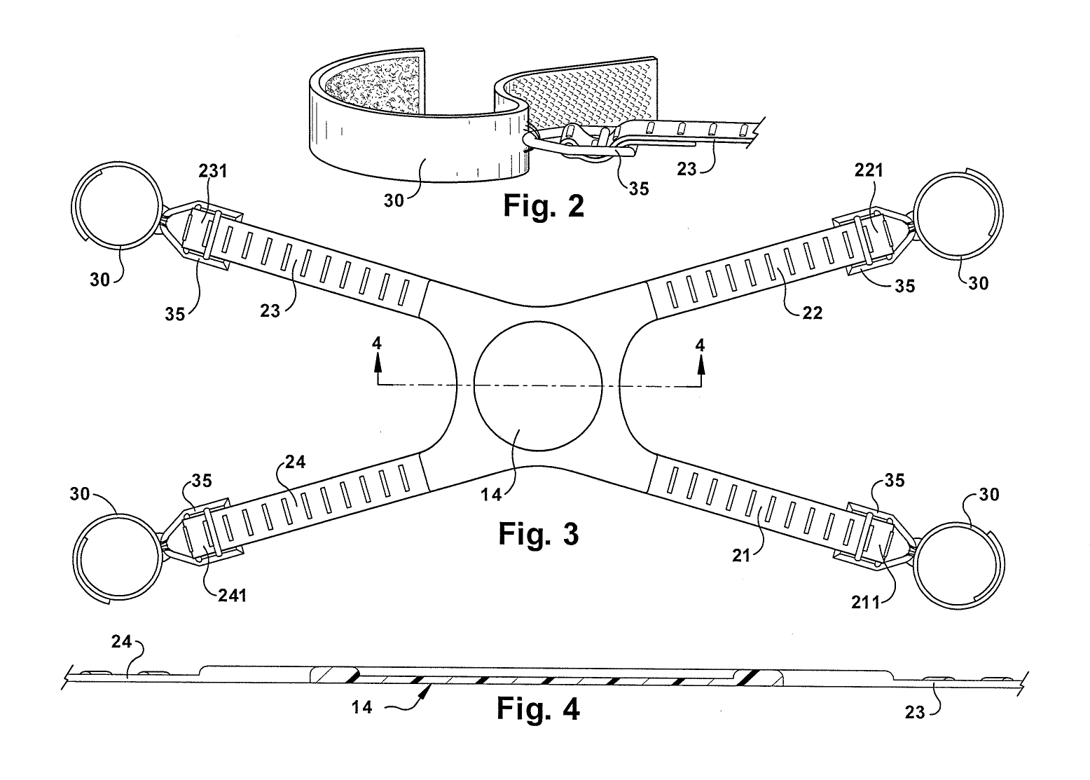

As shown in detail in FIG. 2, a preferred configuration for securement of the elastic member to a dog limb, is a cushioned strap or leg cuff 30 which is made of flexible material and secured about the limb by any suitable means such as hook and loop interconnection such as Velcro™ or other fasteners. As further shown in FIGS. 2 and 3, the distal ends 211, 221, 231, 241 of the limb bands is preferably secured directly to the cushioned leg strap, such as for example by the attachment of an adjustment buckle 35 which is engaged with the limb band 23, as shown. The adjustment buckle 35 thus provides at each distal end of each limb band adjustment of the connecting length between the connecting web 14 and the respective dog leg, whereby the tension of the device between the four dog legs can be adjusted as desired, for example to a generally taut set-up as shown in FIG. 1, or less taut as desired, depending upon the size and leg structure of the dog. The leg cuffs 30 can be made secure about the lower limb just above the ankle and loose enough to not restrict circulation. On some dogs, the cuffs 30 may be located comfortably above the knee where effective resistance can also be achieved.

As shown in the installed position on dog D, the central connecting web 14 from which the four respective limb band 21-24 extend, is located directly underneath the dog's belly, and does not interfere with any of the dog's walking or running motions. Also, the greater amount of elastic material of the central segment 14 further increases the strength and degree of resistance of each of the limb bands 21-24, and can be configured accordingly to adjust these design parameters or for the amount of resistance desired for a dog of any particular sizes. As shown in FIG. 4, the thickness dimensions of the connecting web 14, both in a central region and peripheral region and in each of the limb bands 21-24 can be designed for the degree of displacement desired, along with the design of the elastomeric compound or other suitable material for elasticity and hardness. The elastic portions of the device 10, including the connecting web 14 and the limb bands 21-24, can be made any suitable material or materials with the desired elastic and strength properties, including but not limited to moldable elastomeric compounds, woven material that includes elastic fibers, or combinations thereof. One or more springs of various sizes may alternatively be incorporated into the device, such as for example between the distal ends of the limb bands 21-24 and the cuffs 30, or at the connection of the limb bands to the connecting web 14.

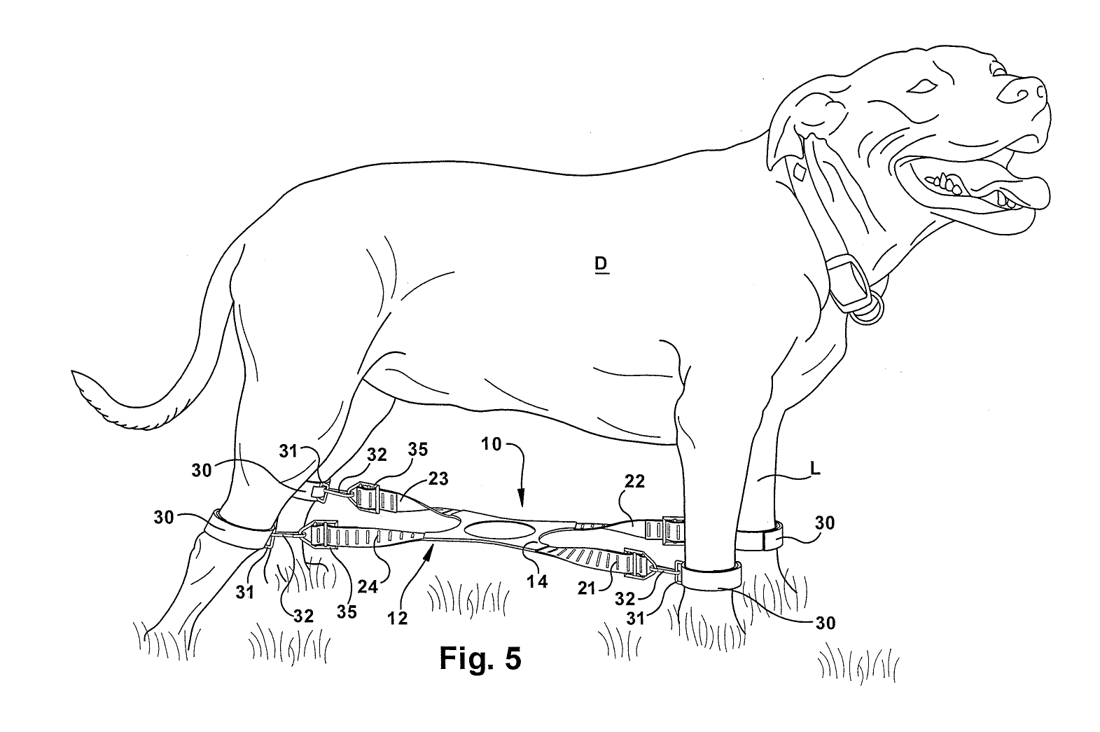

When the device 10 is generally unstretched and loosely taut, for example with the dog standing still and upright, as shown in FIGS. 1 and 5, with each of the cuffs attached to a respective limb, for example about the metacarpal bones between a wrist and knee of each limb, or about the forearm and the tibia, the opposing motion of the dog's legs when walking or running requires stretching of each of the respective limb bands which individually provide the resistance to the dog's muscles in each leg and the resultant exercise benefits. It has been discovered by the inventor that most dogs quickly accommodate and adapt to the device 10 and, once they realize that it does not restrict their freedom of movement, they move and run and play in a normal manner, even with the resistance of the device in place.

A representative dog exercise method of the invention thus involves installing the device 10 on a dog as described by the attachment of each of the leg cuffs 30 and corresponding limb bands 21-24 to the respective legs of the dog. The dog is then acclimated to the device from a standing position and allowed to sense the resistance against the various leg motions in walking, running or other gaits. The dog can be distracted from concentrating on the presence of the device by engaging it in normal play and exercise activities, after which the dog will pay no attention to the presence of device, yet receive all of the benefits of the continuous resistance training The device can be used on the dog for so long as the dog is active and has enough energy to continue to overcome the resistance. At the end of the play/exercise session, the device 10 is easily removed by detachment of the leg cuffs 30.

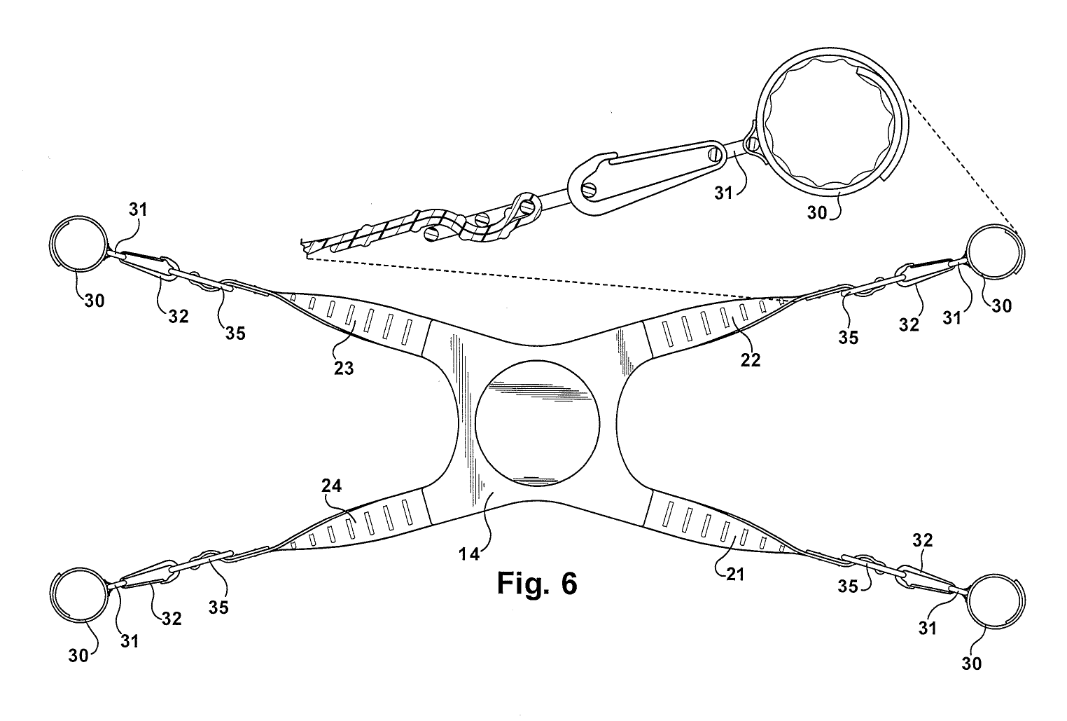

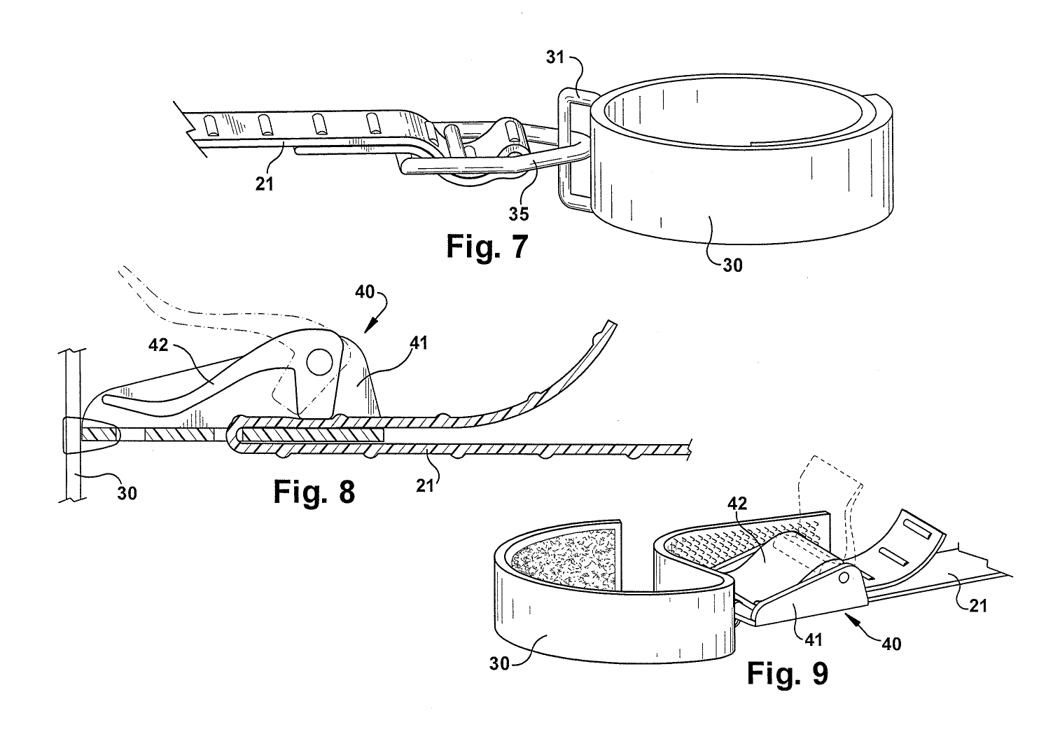

FIGS. 5-6 illustrate an alternate embodiment of the device 10 wherein a quick-release clip 32 is provided in combination with buckle 35 and attached to the cuff 30 by an intermediate link 31. This embodiment allows the leg cuffs 30 to be secured to the dog's legs prior to attachment of each of the limb bands 21-24. Other types of fasteners, buckles and clips can be used for attachment of each of the limb bands 21-24 to the respective dog legs. For example, FIG. 7 illustrates an alternate embodiment wherein a limb band buckle 35 is connected to link 31 which is attached directly to the leg cuff 30. For example the link 31 can be sewn attached to the leg cuff 30. FIGS. 8 and 9 illustrate a still further embodiment which utilizes a camber style buckle 40 which has a body 41 which the limb band (21) passes through in a 180 degree path, and a cam lever 42 which rotates to clamp and lock the limb band in position the body 42. A forward end of the body 42 can be attached directly to the cuff 30.

The disclosure and inventions thus provide a novel device and method for canine exercise and play which significantly enhances the healthful benefits of normal dog motions by introducing ergonomically correct resistance in a non-obtrusive and non-intimidating manner to the dog. By introducing resistance to every motion of the dog's legs, there is increased cardiovascular function and efficiency and muscle strengthening, and increased calorie burn and loss of excess body fat.

1. A canine exercise and training device comprising:
first, second, third and fourth limb bands which extend from a connecting web, the first, second, third and fourth limb bands respectively extending for positioning proximate to first, second, third and fourth limbs of a canine, each of the first, second, third and fourth limb bands attached at distals ends to a cuff adapted for securement about a canine limb

2. The canine exercise and training device of claim 1 wherein the first, second, third and fourth limb bands are made of elastic material.

3. The canine exercise and training device of claim 1 wherein the first, second, third and fourth limb bands are formed integrally with the connecting web.

4. The canine exercise and training device of claim 3 wherein the first, second, third and fourth limb bands and the connecting web are made of the same material having elastic properties.

5. The canine exercise and training device of claim 1 further comprising at least one fastener between a distal end of each limb band and a corresponding cuff.

6. The canine exercise and training device of claim 1 wherein the first, second, third and fourth limb bands extend generally radially from the connecting web.

7. A training device for use with canines, the training device comprising:
a connecting web;
four limb bands which extend from the connecting web, each of the four limb bands having a proximal end attached to the connecting web and a distal end which extends from the connecting web to one of four limbs of a canine, each limb band having elasticity;
a cuff attached to each distal end of each limb band, each cuff adapted for securement to a canine limb.

8. The training device of claim 7 wherein the connecting web and the limb bands are formed as a single piece.

9. The training device of claim 7 wherein the connecting web and the limb bands are comprised of the same elastic material.

10. The training device of claim 7 further comprising a connector between each distal end of each limb band and the corresponding cuff.

11. The training device of claim 10 wherein the connector between each distal end of each limb band and the corresponding cuff is adapted for adjustment of a length of the limb band between the connecting web and the cuff.

12. The training device of claim 10 further comprising a disengageable connector between the distal end of each limb band and the corresponding cuff.

13. The training device of claim 7 wherein the cuffs are comprised of hook and loop interconnecting material.

14. The training device of claim 7 in combination with a canine wherein each of the cuffs are attached to a respective canine limb, and the connecting web is located generally under the canine.

15. The training device of claim 7 further comprising an adjustable connection between at least one of the distal ends of at least one of the limb bands and the corresponding cuff adapted for adjustment of a length of the limb band.
